(19) United States
(12) Patent Application Publication
(10) Pub. No.: US 2008/0169175 A1
(43) Pub. Date: Jul. 17, 2008

(54) Electrical switching device

(75) Inventors: Ralf Weber, Heidelberg (DE); Klaus-Peter Eppe, Waldbrunn (DE)

Correspondence Address: BUCHANAN, INGERSOLL & ROONEY PC, POST OFFICE BOX 1404, ALEXANDRIA, VA, 22313-1404, US

(73) Assignee: ABB Patent GmbH, Ladenburg (DE)

(21) Appl. No.: 12/071,240

(22) Filed: Feb. 19, 2008

Related U.S. Application Data
(63) Continuation of application No. PCT/EP2006/007429, filed on Jul. 27, 2006.

(30) Foreign Application Priority Data
Aug. 17, 2005 (DE) 10 2005 038 776.4
Jul. 5, 2006 (DE) 10 2006 030 953.7

(51) Int. Cl. H01H 9/02

(52) U.S. Cl. 200/295

(57) ABSTRACT

An electrical switching device with a quick-action fastening apparatus is disclosed for snapping the switching device onto a top-hat mounting rail in a service distribution panel. The quick-action fastening apparatus comprising at least one movable tab, which is associated with the fastening face of the switching device housing by means of at least one connecting part, which is integrally formed in one piece with the switching device housing, and in the state in which it is snapped onto the top-hat mounting rail, engages behind a longitudinal edge of the top-hat mounting rail, the connecting part being spring-elastic and being made from a material which has different mechanical properties than the housing material.

### RELATED APPLICATIONS

This application claims priority under 35 U.S.C. §119 to German Application 10 2005 038 776.4 filed in Germany on Aug. 17, 2005, and German Application 10 2006 030 953.7 filed in Germany on Jul. 5, 2006; and as a continuation application under 35 U.S.C. §120 to PCT/EP2006/007429 filed as an International Application on Jul. 27, 2006, designating the U.S., the entire contents of which are hereby incorporated by reference in their entireties.

### TECHNICAL FIELD

The disclosure relates to an electrical switching device, e.g., a line residual-current circuit breaker or motor circuit breaker with a quick-action fastening apparatus.

### BACKGROUND INFORMATION

Such electrical switching devices are installed in an electrical service distribution panel by them being snapped onto a standard mounting rail, in particular onto a top-hat mounting rail. Such a top-hat mounting rail has a U shape, with cheeks, which protrude in opposite directions, being integrally formed at the free ends of the limbs, the free edges of said cheeks acting as fastening edges for an electrical device.

For simplification purposes, only a line circuit breaker will be considered here by way of example.

Such a line circuit breaker has a housing made from an insulating material with front-panel sides and narrow sides and a fastening side, in which a cutout is introduced whose delimiting walls run at right angles to the fastening side. A delimiting wall is provided with a tab-like projection, which projects toward the opposite delimiting wall, is integrally formed on the line circuit breaker and forms a fixed latching tab.

The selection of the insulating material for the housing usually takes place on the basis of the fact that the housing should have good electrical insulation properties with at the same time a high mechanical hardness.

A so-called movable tab is arranged on the opposite delimiting wall, which tab is pressed in a sprung manner inward into the cutout, i.e. in the direction of the opposite stationary tab.

The top-hat mounting rail is installed horizontally in the service distribution panel, the free limbs of the top-hat mounting rail being aligned vertically. For fitting purposes, the line circuit breaker is therefore suspended with its fixed tab onto the upper longitudinal edge in such a way that the fixed tab engages behind this edge. As a result of the line circuit breaker being pivoted toward the top-hat mounting rail about the suspension point, the movable tab moves toward the lower edge of the top-hat mounting rail and, when pressed in further, it latches the movable tab in behind this lower edge.

In general, the movable tab is integrally formed fastening side and is pressed inward into the cutout against a stop by means of, for example, a helical compression spring. For dismantling purposes, the slide is moved away from the top-hat mounting rail by means of a tool, for example a screwdriver, so that the movable or moving tab comes free from the top-hat mounting rail. By the line circuit breaker being pivoted in a direction opposite to the fitting movement, the line circuit breaker can be removed from the top-hat mounting rail.

The quick-action fastening therefore normally comprises at least two parts, namely a slide and a printing error, which presses the slide inward against the top-hat mounting rail. This means increased warehousing requirements and also increased fitting complexity.

EP 0 602 305 A1 has disclosed an electrical switching device with a quick-action fastening, in which a latching tab is integrally formed on a slide, which is arranged at right angles with respect to the longitudinal extent of the top-hat mounting rail. This slide is connected to the housing via a so-called bending web, so that the slide can be folded down about a spindle, which runs parallel to the longitudinal extent of the top-hat mounting rail and is formed by a weakened wall-thickness portion. The slide for this reason requires a special additional guide arrangement in order that the slide can be pressed in a sprung manner against the adjacent free longitudinal edge of the top-hat mounting rail and in the process moves at right angles with respect to the longitudinal extent of the top-hat mounting rail.

### SUMMARY

The object of the disclosure is to provide an electrical switching device with a quick-action fastening, in which additional guidance of the slide is avoided and manageable latching and unlatching of the movable tab is ensured without any additional component parts independently of the material selection for the housing, so that the switching device with the quick-action fastening can therefore be manufactured in a simple and cost-effective manner.

According to the disclosure, the quick-action fastening apparatus therefore comprises at least one movable tab, which is associated with the fastening face of the switching device housing by means of at least one connecting part, which is integrally formed in one piece with the switching device housing, and, in the state in which it is snapped on to the top-hat mounting rail, engages behind a longitudinal edge of the top-hat mounting rail, the connecting part being spring-elastic and being made from a material which has different mechanical properties than the housing material.

In particular, in this case the connecting part is a spring-elastic web, which is made from a material which has different spring-elastic properties than the housing material, with the result that sprung latching of the switching device on the top-hat mounting rail is made possible independently of the spring-elastic properties of the housing material.

In accordance with an exemplary embodiment of the disclosure, the movable tab is integrally formed on a slide, which is guided by means of the at least one spring-elastic web, which is integrally formed in one piece with the switching device housing.

As a result of the guidance of the slide by means of the spring-elastic web, it is no longer necessary to provide a separate guide part, so that the construction is very simple. The housing and the quick-action fastening apparatus can be produced in one piece. It is no longer necessary to fit further parts such as an additional compression spring, for example.

As a result of the fact that the connecting part is made from a material with different mechanical properties than the housing material, its spring-elastic properties can be fixed independently of those of the housing and can be optimized for the intended use. This is particularly advantageous when the material for which the housing is constructed has unfavorable spring properties.

This can be the case when the housing material is a glass-fiber-reinforced plastic material, for example. Although this is very robust and has good electrical insulation properties, it can also be relatively stiff and inelastic. As a result, it would only be possible with great difficulty, if the web were to be integrally formed on a connecting part made from this material, for it to be unlatched from the top-hat mounting rail during dismantling of the switching device. In order that the web can nevertheless be brought into the unlatching position without an incomparable amount of force expenditure, the connecting part would need to be designed to be correspondingly thin. However, there is then again the risk of it breaking easily.

In an exemplary switching device according to the disclosure, the connecting part which is integrally formed in one piece with the housing has greater spring elasticity than the housing. It can then be dimensioned in such a way that it has sufficient thickness and can nevertheless be bent with an acceptable amount of force expenditure, so that the web can be latched and unlatched easily although the housing is otherwise inelastic.

Advantageously, the switching device housing and the quick-action fastening apparatus are produced in a two-component injection-molding process. A two-component injection-molding process makes it possible to connect a plurality of injection-molded parts made from different materials to one another in one piece one after the other in one process sequence. It is therefore possible in simple and cost-effective manner to connect plastic parts made from plastics with different mechanical properties to one another in one piece so that each plastic part has the optimum mechanical properties matched to its intended use.

The mechanical properties by which the housing and the fastening apparatus, which is integrally formed thereon in one piece, differ are in particular the modulus of elasticity and the tenacity or brittleness, and also the hardness.

A further exemplary embodiment of the disclosure provides that two mutually opposite movable tabs are associated with the fastening face by means of spring-elastic webs, which are integrally formed in one piece with the switching device housing. In this case, the movable tabs can be integrally formed on in each case one slide, which slides are guided by means of the spring-elastic webs, which are integrally formed in one piece with the switching device housing.

With the exemplary embodiment, in the case of an electrical switching device as configured, the fitting device can be independent of the installation division of the device.

### BRIEF DESCRIPTION OF THE DRAWING

The invention and further advantageous configurations and improvements and further advantages will be explained and described in more detail with reference to the drawing, in which an exemplary embodiment of the invention is illustrated and in which:

FIG. 1 shows a view into a shell half of an exemplary line circuit breaker according to the disclosure, without internals.

### DETAILED DESCRIPTION

An exemplary electrical line circuit breaker, with reference to which the disclosure will be explained in more detail, has a housing made from plastic, which comprises two housing parts in the form of half-shells, which housing parts are positioned against one another with their free edges, or comprises one housing half-shell, which is closed by means of a cover lid.

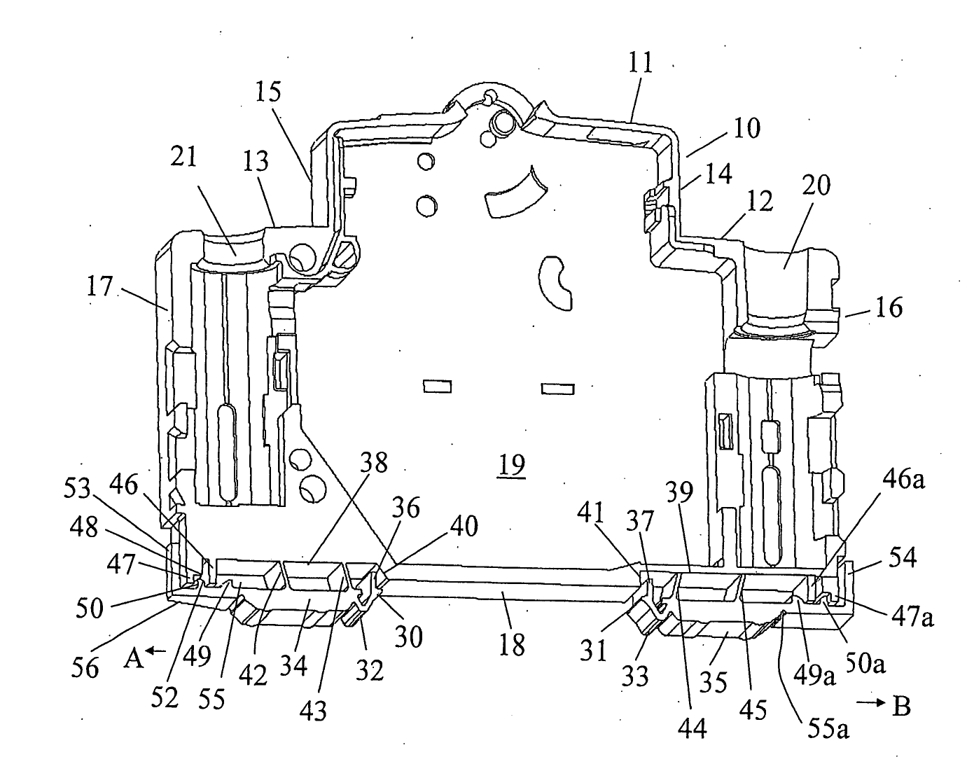

A contact point, a switching mechanism, an electromagnetic or a thermal release, an arc-quenching device and connection terminals are located within the housing of a line circuit breaker. These are not illustrated in FIG. 1 since they are generally customary.

The housing lower part 10 illustrated in FIG. 1, which is a housing lower part in the form of a half-shell, has a front front-panel face 11 and two rear front-panel faces 12 and 13, which are arranged at a distance therefrom, and two front side walls 14, 15, which are aligned approximately at right angles with respect to the front front-panel faces 11 and the rear front-panel faces 12, 13 and connect the two to one another. Rear side faces 16 and 17 adjoin the rear front-panel faces 12 and 13, which rear side faces 16 and 17 become a fastening side 18, which is aligned approximately parallel to the front front-panel face and the rear front-panel faces 11, 12, 13 and at right angles with respect to the front side faces 14, 15 or the rear side faces 16, 17.

The line circuit breaker is formed as a so-called base. The housing lower part 10 has a housing broad side 19, so that a shell shape is formed with the broad side or broad side wall 19 and the front and rear front-panel and side walls and with the fastening wall on the fastening side 18. It is merely additionally mentioned that cutouts 20, 21 for connection terminals are provided in the region of the rear front-panel and side walls 16, 17.

The exemplary embodiment of the fastening face at 18 will now be described. Here, two movable tabs 30 and 31 are provided which are connected to a slide 34, via a V shape 32, 33, whose open side points toward the fastening face 18.

The slides 34, 35 run with their longitudinal extent parallel to the bottom or fastening wall 18 and their inner ends, i.e. their opposite ends, are adjoined by the V shapes 32, 33, the length of the free limbs 36, 37 on which the tabs 30, 31 are integrally formed is longer than the thickness of the slides 34, 35, measured at right angles with respect to the fastening plane or wall 18. Recesses 38 and 39 are provided on both sides in the fastening wall 18, on the fastening side, i.e. outside the housing 10, which recesses 38 and 39 are delimited inward, i.e. toward the center of the fastening side or wall 18, by means of a terminating wall 40, 41, the terminating wall 40 forming an oblique angle with respect to the fastening wall 18 or enclosing an obtuse angle with it, which angle is open toward the housing interior.

The fastening of the slides 34 and 35 in the recesses 38 and 39 takes place by means of in each case two webs 42, 43; 44, 45, which each form an acute angle α in the position shown in FIG. 1 with the inner face of the recesses 38, which acute angle α is open toward the respective tabs 30 or 31.

The webs 42, 43; 44, 45 are integrally formed in one piece with the housing shell 10. They are made from a material with different mechanical properties than the rest of the housing. The material from which the webs 42, 43; 44, 45 are made has a lower modulus of elasticity than the material from which the rest of the housing is made. The webs therefore have a sufficiently large thickness, so that they are integrally formed in stable fashion and cannot easily be torn away, and nevertheless have sufficient spring elasticity, so that the slides 34, 35 can be brought from the position shown into a position in which the angles α are obtuse, to be precise without an incomparably large amount of force needing to be applied. The slides 34, 35 can therefore be pressed outward in the arrow direction A or B, the webs elastically deforming in 42, 43; 44, 45.

A two-component injection-molding process is used in order first to integrally form the housing shells and then to integrally form the webs 42, 43; 44, 45 and possibly also the slides 34, 35 with the movable tabs 30, 31 made from a material with different mechanical properties than the housing material in one piece on said housing shells.

Strips 46, 47, which run at right angles with respect to the depressions and form an interspace 48 between them, are integrally formed in the depressions 38, 39 in the region of the rear side walls 16, 17. The same strips are also located on the other side. On the side facing the depression 38, the slide has latching tabs 49 and 50, which have a saw-tooth form, when the latching tab 49 is positioned closer to the tab 30 the sloping face 51 being positioned toward the side opposite the tab 30 and the sloping face 52 being positioned on the latching tab 50 in the direction toward the tab 30. In the position illustrated in FIG. 1, the outer tab 50 engages in the interspace 48 and the inner tab 49 is located on that side of the strip 46 which is positioned toward the tab 30.

If a force is exerted on the slide 34, for example in arrow direction A, the latching tab 50 moves toward the strip 47, so that the movement of the slide in arrow direction A is limited. Each slide 34, 35 has a web 53, 54, which protrudes at right angles with respect thereto, at the end which is located outside the rear side wall. A weakened portion 55 is located in the vicinity of the tabs 49 between the tab 49 and the tab 30, so that the region 56 on which the web 53 is integrally formed can be pivoted about the weakened portion 55.

With the aid of the exemplary two-component injection-molding process to be applied according to the disclosure, the web in the region of the weakened portion 55 can in turn be produced from a material with different mechanical properties. Advantageously, a material with high strength is used in this region, so that a stable joint is ensured despite the weakening.

If the switch is intended to be dismantled, the web 53 is crossed about the weakened portion in the counterclockwise direction by means of a screwdriver; in this way the latching tab 52 comes free from the strip 47, so that the slide can be displaced further toward the left in arrow direction A than up to the point at which the latching tab 50 bears against the strip 47. In order that the line circuit breaker can also be removed from the assembly when the connection terminals of a plurality of line circuit breakers are mechanically and electrically coupled by means of a busbar, the region 56 can be displaced by means of further deformation about the weakened portion 55 further in the arrow direction A, it being possible as a result of the sloping face 51 for the latching tab 49 to slide behind the strip 46.

The same also takes place on the slide 35. Here the strip 46a and the strip 47a as well as the latching tabs 49a and 50a can be seen.

The webs 42, 43; 44, 45, which are arranged parallel to one another, remain parallel even when the slides 34, 35 are displaced out of the position illustrated in the FIGURE in arrow direction A or B. The webs 42, 43; 44, 45 with the slides 430, 35 to a certain extent snap over from the position illustrated in the FIGURE into the position in which the slides or the tabs 30, 31 are removed from the free longitudinal edges of the top-hat mounting rail.

The invention has been explained with reference to an exemplary line circuit breaker. It can also be applied to any service device which is intended to be latched onto a top-hat mounting rail. Are in

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. An electrical switching device with a quick-action fastening apparatus for snapping the switching device onto a top-hat mounting rail in a service distribution panel, the quick-action fastening apparatus comprising at least one movable tab, which is associated with the fastening face of the switching device housing by means of at least one connecting part, which is integrally formed in one piece with the switching device housing, and in the state in which it is snapped onto the top-hat mounting rail, engages behind a longitudinal edge of the top-hat mounting rail, the connecting part being spring-elastic and being made from a material which has different mechanical properties than the housing material.

2. The electrical switching device according to claim 1, the connecting part being a spring-elastic web, which is made from a material which has different spring-elastic properties than the housing material, with the result that sprung latching of the switching device on the top-hat mounting rail is made possible independently of the spring-elastic properties of the housing material.

3. The electrical switching device as claimed in claim 1, the movable tab being integrally formed on a slide, which is guided by means of the at least one spring-elastic web, which is integrally formed in one piece with the switching device housing.

4. The electrical switching device as claimed in claim 1, two mutually opposite movable tabs being associated with the fastening face by means of spring-elastic webs, which are integrally formed in one piece with the switching device housing.

5. The electrical switching device as claimed in claim 4, the movable tabs being integrally formed on in each case one slide, which slides are guided by means of the spring-elastic webs, which are integrally formed in one piece with the switching device housing.

6. The electrical switching device as claimed in claim 1, in the latched-on state the webs with the fastening face assuming an acute angle, which is open toward the opposite tab.

7. The electrical switching device as claimed in claim 1, two strips, which protrude at right angles with respect to the fastening face and interact with latching tabs, which are integrally formed on the slides, are integrally formed on the fastening face in the region of the rear side faces.

8. The electrical switching device as claimed in claim 1, a weakened portion being provided between the movable tab and that end of each slide which protrudes outward, about which weakened portion the end of each slide can be pivoted for dismantling purposes.

9. The electrical switching device as claimed in claim 1, the switching device housing and the fastening apparatus being connected in one piece.

10. The electrical switching device as claimed in claim 1, the switching device housing and the quick-action fastening apparatus being produced in a two-component injection-molding process.

11. The electrical switching device as claimed in claim 2, the movable tab being integrally formed on a slide, which is guided by means of the at least one spring-elastic web, which is integrally formed in one piece with the switching device housing.

12. The electrical switching device as claimed in claim 3, two mutually opposite movable tabs being associated with the fastening face by means of spring-elastic webs, which are integrally formed in one piece with the switching device housing.

13. The electrical switching device as claimed in claim 5, in the latched-on state the webs with the fastening face assuming an acute angle, which is open toward the opposite tab.

14. The electrical switching device as claimed in claim 6, two strips, which protrude at right angles with respect to the fastening face and interact with latching tabs, which are integrally formed on the slides, are integrally formed on the fastening face in the region of the rear side faces.

15. The electrical switching device as claimed in claim 7, a weakened portion being provided between the movable tab and that end of each slide which protrudes outward, about which weakened portion the end of each slide can be pivoted for dismantling purposes.

16. The electrical switching device as claimed in claim 8, the switching device housing and the fastening apparatus being connected in one piece.

17. The electrical switching device as claimed in claim 9, the switching device housing and the quick-action fastening apparatus being produced in a two-component injection-molding process.
